(19) United States
(12) Patent Application Publication
(10) Pub. No.: US 2025/0272137 A1
(43) Pub. Date: Aug. 28, 2025

(54) DYNAMIC INTERRUPT ROUTING TO MANAGE APPLICATION PERFORMANCE AND REDUCE LATENCY

(71) Applicant: DELL PRODUCTS L.P., Round Rock, TX (US)

(72) Inventors: Suraj M. Varma, Portland, OR (US); Farzad Khosrowpour, Pflugerville, TX (US)

(21) Appl. No.: 18/584,465

(22) Filed: Feb. 22, 2024

(51) Int. Cl. G06F 9/48

(52) U.S. Cl. CPC G06F 9/4812

(57) ABSTRACT

An information handling system stores an interrupt steering mode, and creates a processor set in response to receiving an assignment of the processor set to an application. In response to detecting an interrupt associated with the application, the system measures a current load of a particular processor included in the processor set. If the current load of the processor is less than a target processor load, then the system assigns the particular processor to handle the interrupt.

### FIELD OF THE DISCLOSURE

The present disclosure generally relates to information handling systems, and more particularly relates to dynamic interrupt routing to manage application performance and reduce latency.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system stores an interrupt steering mode, and creates a processor set in response to receiving an assignment of the processor set to an application. In response to detecting an interrupt associated with the application, the system measures a current load of a particular processor included in the processor set. If the current load of the processor is less than a target processor load, then the system assigns the particular processor to handle the interrupt.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a block diagram of an information handling system for dynamic interrupt routing to manage application performance and reduce latency, according to an embodiment of the present disclosure;

FIG. 3 is a flowchart of a method for dynamic interrupt routing to manage application performance and reduce latency, according to an embodiment of the present disclosure; and

FIG. 4 is a flowchart of a method for routing interrupts associated with an application optimized for lower latency and/or higher performance, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

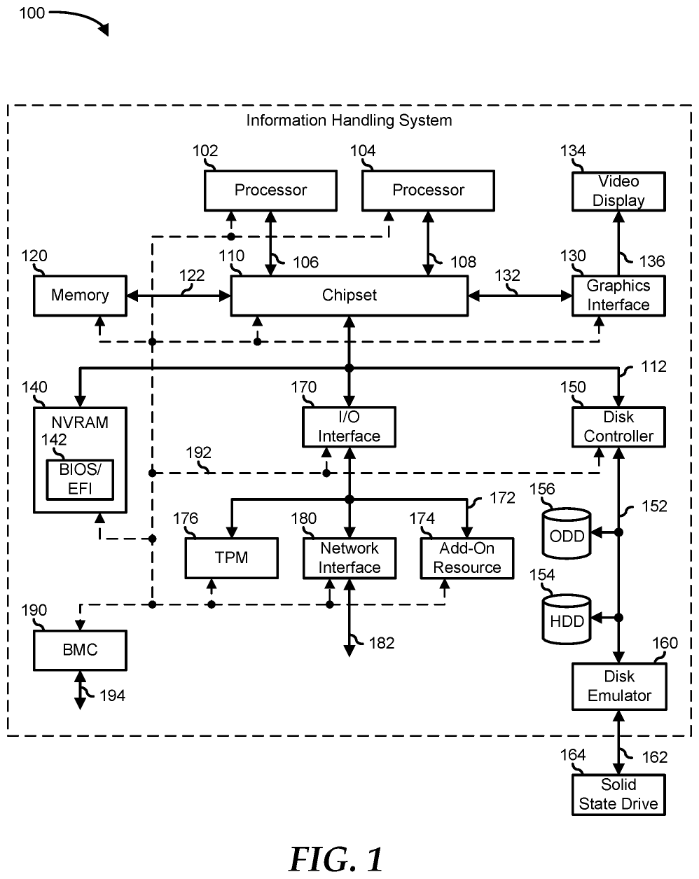

FIG. 1 illustrates an embodiment of an information handling system 100 including processors 102 and 104, a chipset 110, a memory 120, a graphics adapter 130 connected to a video display 134, a non-volatile RAM (NV-RAM) 140 that includes a basic input and output system/extensible firmware interface (BIOS/EFI) module 142, a disk controller 150, a hard disk drive (HDD) 154, an optical disk drive 156, a disk emulator 160 connected to a solid-state drive (SSD) 164, an input/output (I/O) interface 170 connected to an add-on resource 174 and a trusted platform module (TPM) 176, a network interface 180, and a baseboard management controller (BMC) 190. Processor 102 is connected to chipset 110 via processor interface 106, and processor 104 is connected to the chipset via processor interface 108. In a particular embodiment, processors 102 and 104 are connected together via a high-capacity coherent fabric, such as a HyperTransport link, a QuickPath Interconnect, or the like. Chipset 110 represents an integrated circuit or group of integrated circuits that manage the data flow between processors 102 and 104 and the other elements of information handling system 100. In a particular embodiment, chipset 110 represents a pair of integrated circuits, such as a northbridge component and a southbridge component. In another embodiment, some or all of the functions and features of chipset 110 are integrated with one or more of processors 102 and 104.

Memory 120 is connected to chipset 110 via a memory interface 122. An example of memory interface 122 includes a Double Data Rate (DDR) memory channel and memory 120 represents one or more DDR Dual In-Line Memory Modules (DIMMs). In a particular embodiment, memory interface 122 represents two or more DDR channels. In another embodiment, one or more of processors 102 and 104 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 120 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 130 is connected to chipset 110 via a graphics interface 132 and provides a video display output 136 to a video display 134. An example of a graphics interface 132 includes a Peripheral Component Interconnect-Express (PCIe) interface and graphics adapter 130 can include a four-lane (x4) PCIe adapter, an eight-lane (x8) PCIe adapter, a 16-lane (x16) PCIe adapter, or another configuration, as needed or desired. In a particular embodiment, graphics adapter 130 is provided down on a system printed circuit board (PCB). Video display output 136 can include a Digital Video Interface (DVI), a High-Definition Multimedia Interface (HDMI), a DisplayPort interface, or the like, and video display 134 can include a monitor, a smart television, an embedded display such as a laptop computer display, or the like.

NV-RAM 140, disk controller 150, and I/O interface 170 are connected to chipset 110 via an I/O channel 112. An example of I/O channel 112 includes one or more point-to-point PCIe links between chipset 110 and each of NV-RAM 140, disk controller 150, and I/O interface 170. Chipset 110 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. NV-RAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an institute of electrical and electronics engineers (IEEE) 1394 (Firewire) interface, a proprietary interface, or a combination thereof. Alternatively, SSD 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112 or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral interface 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board, or add-in card disposed within information handling system 100, a device that is external to the information handling system, or a combination thereof.

Network interface 180 represents a network communication device disposed within information handling system 100, on a main circuit board of the information handling system, integrated onto another component such as chipset 110, in another suitable location, or a combination thereof. Network interface 180 includes a network channel 182 that provides an interface to devices that are external to information handling system 100. In a particular embodiment, network channel 182 is of a different type than peripheral interface 172 and network interface 180 translates information from a format suitable to the peripheral channel to a format suitable to external devices.

In a particular embodiment, network interface 180 includes a NIC or host bus adapter (HBA), and an example of network channel 182 includes an InfiniBand channel, a Fibre Channel, a Gigabit Ethernet channel, a proprietary channel architecture, or a combination thereof. In another embodiment, network interface 180 includes a wireless communication interface, and network channel 182 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 182 can be connected to an external network resource (not illustrated). The network resource can include another information handling system, a data storage system, another network, a grid management system, another suitable resource, or a combination thereof.

BMC 190 is connected to multiple elements of information handling system 100 via one or more management interface 192 to provide out of band monitoring, maintenance, and control of the elements of the information handling system. As such, BMC 190 represents a processing device different from processor 102 and processor 104, which provides various management functions for information handling system 100. For example, BMC 190 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 190 can vary considerably based on the type of information handling system. BMC 190 can operate in accordance with an Intelligent Platform Management Interface (IPMI). Examples of BMC 190 include an Integrated Dell® Remote Access Controller (iDRAC).

Management interface 192 represents one or more out-of-band communication interfaces between BMC 190 and the elements of information handling system 100, and can include an Inter-Integrated Circuit (I2C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

BMC 190 operates to monitor and maintain system firmware, such as code stored in BIOS/EFI module 142, option ROMs for graphics adapter 130, disk controller 150, add-on resource 174, network interface 180, or other elements of information handling system 100, as needed or desired. In particular, BMC 190 includes a network interface 194 that can be connected to a remote management system to receive firmware updates, as needed or desired. Here, BMC 190 receives the firmware updates, stores the updates to a data storage device associated with the BMC, transfers the firmware updates to NV-RAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100 or is integrated onto another element of the information handling system such as chipset 110, or another suitable element, as needed or desired. As such, BMC 190 can be part of an integrated circuit or a chipset within information handling system 100. An example of BMC 190 includes an iDRAC, or the like. BMC 190 may operate on a separate power plane from other resources in information handling system 100. Thus BMC 190 can communicate with the management system via network interface 194 while the resources of information handling system 100 are powered off. Here, information can be sent from the management system to BMC 190 and the information can be stored in a RAM or NV-RAM associated with the BMC. Information stored in the RAM may be lost after power-down of the power plane for BMC 190, while information stored in the NV-RAM may be saved through a power-down/power-up cycle of the power plane for the BMC.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple central processing units (CPUs) and redundant bus controllers. One or more components can be integrated together. Information handling system 100 can include additional buses and bus protocols, for example, I2C and the like. Additional components of information handling system 100 can include one or more storage devices that can store machine-executable code, one or more communications ports for communicating with external devices, and various input and output (I/O) devices, such as a keyboard, a mouse, and a video display.

For purposes of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as processor 102, a programmable logic array (PLA), an embedded device such as a System-on-a-Chip (SoC), or other control logic hardware. Information handling system 100 can also include one or more computer-readable media for storing machine-executable code, such as software or data.

Devices in an information handling system typically employ interrupts to notify one or more processors, also referred to herein as CPUs, that a particular device in the system requires attention. Traditional interrupt routing on information handling systems, whether client or server, is generally static. This means that the interrupt routing table is typically fixed either at the system boot at the BIOS or the operating system level through an interrupt descriptor table. Static routing of interrupts can lead to high interrupt latency, especially on systems that host a large number of devices. In addition, when multiple devices generate interrupts at the same time, it can result in an interrupt storm that could overwhelm a processor and cause degradation in system performance. Further, for processor cores of the processor that are parked or in sleep mode, scheduling interrupts on them would result in additional latency to wake up the core and additional power consumption that can be avoided. To address these and other concerns, the present disclosure provides a system and method for dynamic interrupt routing to manage application performance and reduce latency, resulting in increased responsiveness. For example, the dynamic interrupt routing may address the aforementioned issues by dynamically routing an interrupt to a processor that is best capable of handling the interrupt.

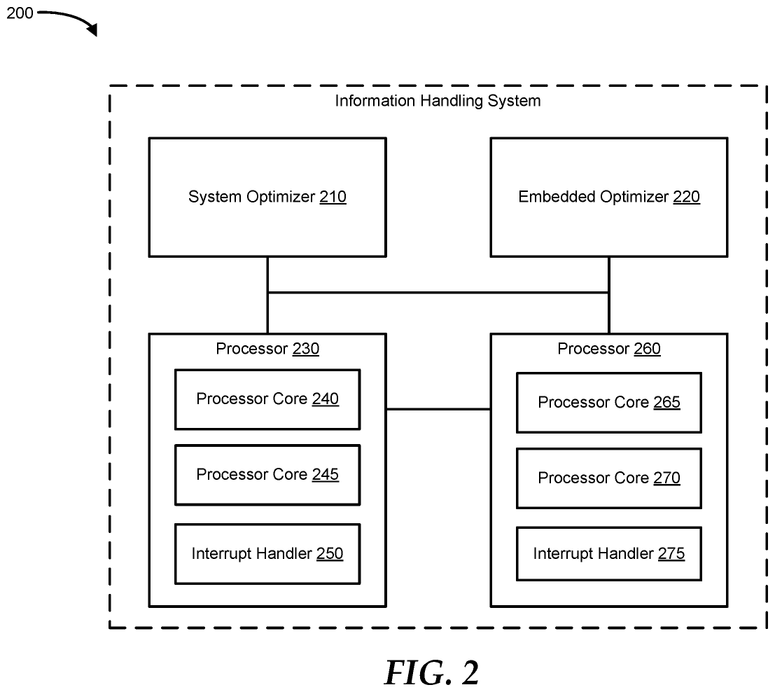

FIG. 2 shows a portion of an information handling system 200 according to at least one embodiment of the present disclosure. In particular, information handling system 200, which is similar to information handling system 100 of FIG. 1, may be configured to dynamically route an interrupt to a processor or a processor core that is capable of handling or servicing the interrupt. Information handling system 200 includes a system optimizer 210, an embedded optimizer 220, and processors 230 and 260. Processor 230, which is similar to processor 102 of FIG. 1, includes processor cores 240 and 245, and an interrupt handler 250. Processor 260, which is similar to processor 104 of FIG. 1, includes processor cores 265 and 270, and an interrupt handler 275.

System optimizer 210 may be communicatively coupled to embedded optimizer 220 and processors 230 and 260. The components of information handling system 200 may be implemented in hardware, software, firmware, or any combination thereof. The components shown are not drawn to scale and information handling system 200 may include additional or fewer components. For example, information handling system 200 may include one or more than two processors. Also, each processor may include one or more than two processor cores. In addition, connections between components may be omitted for descriptive clarity.

Information handling system 200 may route an interrupt based on one or more factors, such as the priority of the interrupt, the type of device associated with the interrupt, the current load of the processor, the target load of the processor, processor core parking condition, and interrupt steering mode when the processor or processor core was unparked or awaken. Interrupt steering mode may be a setting to route an interrupt to a particular processor, such as an unparked processor. In addition, information handling system 200 may utilize a processor set to route the interrupt. In particular, information handling system 200 may be configured according to one or more interrupt routing scenarios that include: using the target load of the processor, processor core parking status, affinity mask of the interrupt to a processor set, and machine learning classification, among others.

System optimizer 210 may be a management application to manage and/or monitor one or more applications and/or devices in information handling system 200. In particular, system optimizer 210 may be configured to automate performance tuning and/or optimization of one or more applications in information handling system 200. System optimizer 210 may be located remotely from or installed locally at information handling system 200. In addition, system optimizer 210 may communicate with embedded optimizer 220 via one or more communication channels, such as a sideband or out-of-band communication channel, a wide area network, a local area network, a wireless local area network, a wireless personal area network, a wireless wide area network, etc.

Embedded optimizer 220 may be a firmware implemented in a hardware module that includes a memory and a processing unit. The firmware may be configured to monitor and/or control the performance of processors 230 and 260 with system optimizer 210. For example, embedded optimizer 220 may be configured to measure a utilization percentage of processor, processor core, or logical processor that is attributed to servicing interrupts. The measurement of the utilization percentage may be performed by attributing the processor time used to service an interrupt service routine on that processor, processor core, or logical processor. For example, embedded optimizer 220 may measure the utilization of processors 230 and 260 by interrupt handlers 250 and 275, respectively. If a current interrupt load of a processor or processor core is less than a target interrupt load of the processor, then the interrupt steering mode may be set to route a detected interrupt to the processor or processor core. Otherwise, the interrupt steering mode may be set to route the detected interrupt to another processor or processor core with a current interrupt load that is less than its target interrupt load. For example, if processor 230 is currently at 1% interrupt load and a target interrupt load is 10%, then embedded optimizer 220 may retain steering the interrupt to processor 230, such as by retaining the setting of the interrupt steering mode to processor 230 so that it continues to service interrupts. In another example, if processor 260 is currently at 6% interrupt load and the target interrupt load is 5%, then embedded optimizer 220 may steer future interrupts to processor 230. For example, embedded optimizer 220 may set the interrupt steering mode to processor 230 so that future interrupts get serviced by processor 230 instead of processor 260.

Embedded optimizer 220 may be configured to schedule interrupts based on one or more conditions of a processor or processor core, such as if the processor core is parked or in sleep mode if the processor core is unmasked or in a wake mode, or if a processor core is unparked for a certain period. Embedded optimizer 220 can detect if a processor core of processor 230 is currently parked by an operating system. For example, if embedded optimizer 220 detects that processor core 240 is currently parked, then embedded optimizer 220 may modify the interrupt steering mode to schedule interrupts on other processor cores of processor 230, except processor core 240. When processor core 240 gets unparked and the duration of being unparked exceeds a set processor core unparking threshold in the operating system, then embedded optimizer 220 may restore the interrupt steering mode to include processor core 240. Alternately, if the core unparking threshold was set to zero, then embedded optimizer 220 may restore the interrupt steering mode for processor core 240 so that it can start handling interrupts.

Embedded optimizer 220 may be configured to use software affinity masks for processes and/or threads of interest in optimizing their performance by utilizing processor sets. A processor set may include a cluster of one type of processor core. For example, processor core types include a performance core (P-core) and an efficiency core (E-core). P-cores are designed for high-performance tasks that require more computational power. E-cores are designed for routine tasks and require less power. For example, processor cores 240 and 245 may be E-cores. In another example, processor core 265 may be a P-core processor core 270 may be an E-core. Accordingly, processor 230 may include a set of processor cores that includes processor cores 240 and 245. Processor 260 may include two sets of processor cores, wherein a first processor set includes processor core 265 while a second processor set includes a processor core 270. Processor 230 and processor 260 may also include other types of processor cores. For example, processor 230 may include at least one P-core. Although, the examples used herein are types of processors based on performance, one of skill in the art will appreciate that other processor types may be used without departing from the present disclosure.

When a user needs additional performance boost or responsiveness for an application, system optimizer 210 can assign the application to a processor set. Accordingly, interrupts from devices that target the threads of that application may be routed to the processor set to handle. Providing target processor sets for interrupt handling may help optimize the application performance since interrupts for the application get priority on these processor cores. Meanwhile, other processes/threads on the system may continue using the P-cores and/or remaining E-cores.

System optimizer 210 may also be configured to use machine learning to learn the behavior of the interrupts and/or applications with particular quality of service and latency requirements in information handling system 200. For example, machine learning may be used over a period of time to determine how the interrupts are routed. This may be used to classify processor cores according to interrupt distribution density. Machine learning architectures that are used for deep learning may include deep neural networks, deep belief networks, deep reinforcement learning, recurrent neural networks, and convolutional neural networks. Further, the machine learning may be supervised, semi-supervised, or unsupervised. For example, in supervised machine learning, processors 230 and/or 260 may be programmed or configured to receive training data or a plurality of data instances which may result in an observation that includes a mapping of processors and/or processor cores to interrupts. System optimizer 210 may then be matched to a processor core via dynamic interrupt routing based on the observation and quality of service latency requirements.

Those of ordinary skill in the art will appreciate that the configuration, hardware, and/or software components of information handling system 200 depicted in FIG. 2 may vary. For example, the illustrative components within information handling system 200 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

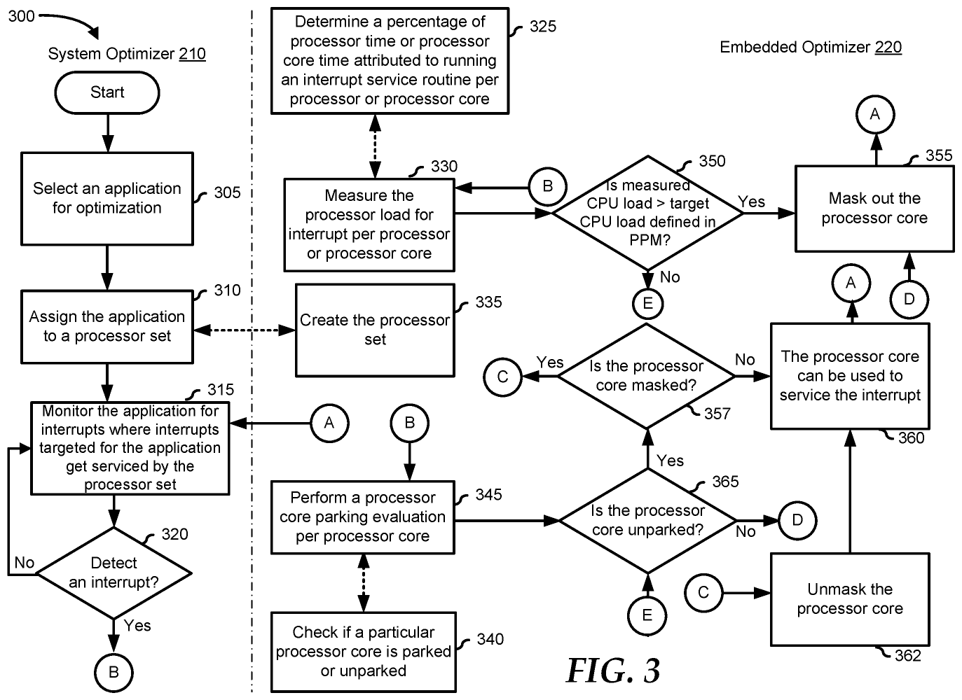

FIG. 3 shows a flowchart of a method 300 for dynamic interrupt routing to manage application performance and reduce latency. Dynamic interrupt routing is a technological improvement over static interrupt routing with improved system performance, increased efficiency, and reliability while providing reduced latency. The dynamic interrupt routing mechanism may route an interrupt at runtime based on certain factors, such as system usage and device hints. Dynamic interrupt routing may dynamically prioritize a processor and configure the processor to receive and handle the interrupt. Method 300 may be performed by any suitable component of information handling system 200 of FIG. 2 including, but not limited to, system optimizer 210 and embedded optimizer 220. While embodiments of the present disclosure are described in terms of the components of information handling system 200, it should be recognized that other components may be utilized to perform the described method.

Method 300 typically starts at block 305 where a user may select an application for optimization. For example, the user may utilize a user interface in system optimizer 210 to select the application. The method proceeds to block 310 where system optimizer 210 may assign the application to a set of processor cores. For example, system optimizer 210 may assign the application to a set of E-cores. At this time, system optimizer 210 may communicate the assignment to embedded optimizer 220 via a communication channel. The method may proceed to block 315 wherein system optimizer 210 may monitor the application for interrupts. The interrupts targeted for the application may get serviced by the processor cores of the assigned processor set. The method may proceed to decision block 320 where system optimizer 210 may determine whether it detects an interrupt is generated that is associated with the application. If an interrupt is detected, then the “YES” branch is taken, and the method proceeds to blocks 345 and 330. If an interrupt is not detected, then the “NO” branch is taken and the method proceeds to block 315.

At block 335, embedded optimizer 220 may receive the processor set assignment from system optimizer 210. Embedded optimizer 220 may create the processor set based on the assignment. For example, embedded optimizer 220 may create the processor set of E-cores. At block 345, embedded optimizer 220 may perform a processor core parking evaluation per processor core in the processor set. Performing the processor core parking evaluation may include block 340, where embedded optimizer 220 may check whether one or more processor cores of the processor set are parked or unparked. Embedded optimizer 220 may also determine when the processor core(s) was unparked. A waiting period may be used after a processor core wakes up before it can be used to handle interrupts. Accordingly, embedded optimizer 220 may wait until after the waiting period is over before providing information regarding the unparked processor core to block 345.

At decision block 365, embedded optimizer 220 may determine whether the processor core is unparked or in sleep mode. If the processor core is unparked, then the “YES” branch is taken, and the method proceeds to decision block 357. If the processor core is parked, then the “NO” branch is taken, and the method proceeds to block 355. At decision block 357 the method determines whether the processor core is masked. If the processor core is masked, then the “YES” branch is taken, and the method proceeds to block 362 where embedded optimizer 220 may unmask the processor core before proceeding to block 360. If the processor core is unmasked, then the “NO” branch is taken, and the method proceeds to block 360.

At block 360, embedded optimizer 220 may use the processor core to service or handle the interrupt. The method may proceed to block 315. At block 355, embedded optimizer 220 may mask out the processor core. The processor core is masked so that the processor core may not be able to handle or service the interrupt. The method may proceed to block 315. At block 330, embedded optimizer 220 may measure current processor load per processor and/or processor core. This may be performed to determine whether the processor and/or the processor core of the processor set assigned to the interrupt has the bandwidth to perform an interrupt service routine to service or handle the interrupt. Performing this function may include block 325 where embedded optimizer 220 may determine a percentage of processor time attributed to running the interrupt service routine per processor and/or per processor core.

The method may proceed to decision block 350 where embedded optimizer 220 may determine whether the current processor load or current processor core load measured at block 330 is greater than a target processor load or a target processor core as defined in a processor power management (PPM) policy. If the current processor load or current processor core load measured in block 330 is greater than the target processor load or target processor core load respectively, then the “YES” branch is taken, and the method proceeds to block 355. If the current processor load or current processor core load measured in block 330 is not greater than the target processor load or target processor core load, then the “NO” branch is taken, and the method proceeds to decision block 365. As such, the “NO” branch is taken, and the method proceeds to decision block 365 if the current processor load or the current processor core load measured in block 330 is less than or equal to the target processor load or the target processor core load.

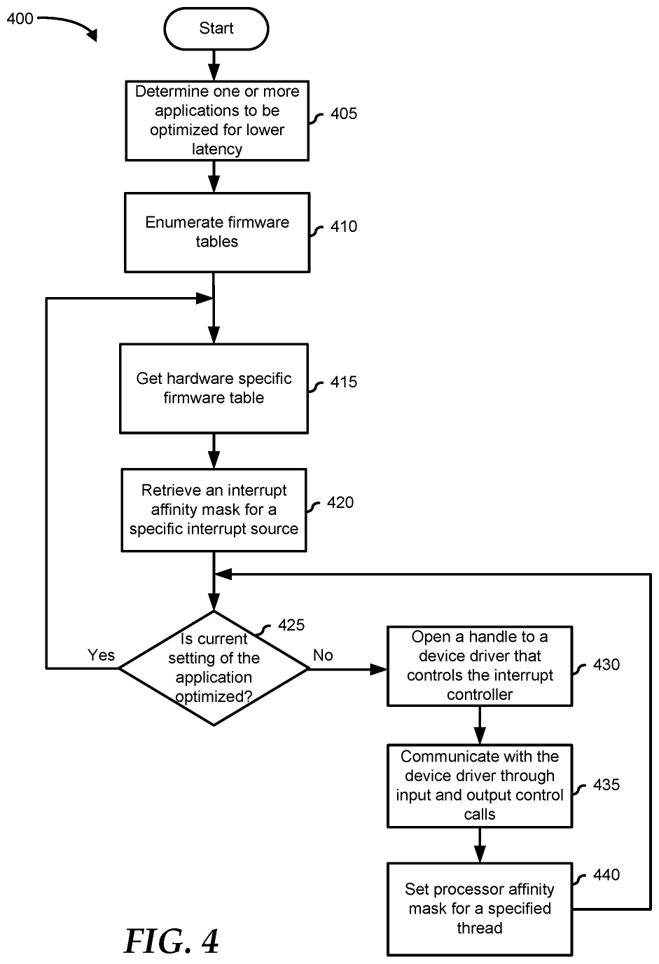

FIG. 4 shows a flowchart of a method 400 for routing interrupts associated with an application optimized for lower latency and/or higher performance. In particular, method 400 may be used to set an affinity mask for processes or threads of interest that are associated with the application by utilizing processor sets. The association may be identified using a lookup table. Method 400 may be performed by any suitable component of information handling system 200 of FIG. 2 including, but not limited to, system optimizer 210 and embedded optimizer 220. While embodiments of the present disclosure are described in terms of the components of information handling system 200 of FIG. 2, it should be recognized that other components may be utilized to perform the described method.

Method 400 typically starts at block 405 where system optimizer 210 may determine one or more applications that may be optimized for lower latency and/or higher performance. For example, a user may select an application that requires lower latency. In another example, system optimizer 210 may select the application based on latency requirements of quality of service measurements. In particular, the selection may be performed based on computer usage analysis and machine learning.

The method proceeds to block 410 where system optimizer 210 may enumerate firmware tables of the information handling system. The firmware tables include a system information table, a memory device table, a processor table, etc. The method proceeds to block 415 where system optimizer 210 may retrieve hardware-specific firmware tables from the information handling system. The firmware table retrieved may include information about interrupt controllers and their configurations. The method proceeds to block 420 where system optimizer 210 may retrieve an interrupt affinity mask for a specific interrupt source. The specific interrupt source may be related to the application selected at block 405. The affinity mask may specify the set of processors or processor cores that can handle the interrupt. Accordingly, a detected interrupt associated with the application may be assigned to the set of processors or processor cores for handling.

The method proceeds to decision block 425 where the system optimizer 210 may determine whether the current setting of the application is optimized. The determination of whether the application is optimized may be based on a defined quality of service that is needed or desired for the application. For example, an audio and/or video application may have to meet certain latency requirements to avoid choppiness. The audio and/or video application may be optimized if it meets the latency requirements. If the current setting of the application is optimized, then the “YES” branch is taken, and the method proceeds to block 415. If the current setting is not optimized, then the “NO” branch is taken, and the method proceeds to block 430.

At block 430, system optimizer 210 may open a handle or a reference to a device driver that controls the interrupt controller associated with the interrupt. The handle or the reference can then be used to access the device driver and perform various operations on the interrupt controller, such as to prioritize interrupt requests from various sources. The method proceeds to block 435 where system optimizer 210 may communicate with the device driver through input and output control (IOCT) calls. The IOCT calls can be used to configure and manage interrupt routing settings. The method may proceed to block 440, where system optimizer 210 may set the processor affinity mask for a specific thread, wherein the thread may be associated with the application. By assigning the specified thread to a particular processor or processor core, system optimizer 210 can control which interrupt is handled by that particular processor or processor core. The assignment may be indicated using a lookup table, wherein system optimizer 210 can query to identify the processor set or processor core set for a particular interrupt. For example, when an interrupt is detected, then the interrupt may be handled by the particular processor or processor core based on the affinity mask.

The term “user” in this context should be understood to encompass, by way of example and without limitation, a user device, a person utilizing or otherwise associated with the device, or a combination of both. An operation described herein as being performed by a user may therefore be performed by a user device, or by a combination of both the person and the device.

Although FIG. 3, and FIG. 4 show example blocks of method 300 and method 400 in some implementations, method 300 and method 400 may include additional blocks, fewer blocks, different blocks, or differently arranged blocks than those depicted in FIG. 3 and FIG. 4. Those skilled in the art will understand that the principles presented herein may be implemented in any suitably arranged processing system. Additionally, or alternatively, two or more of the blocks of method 300 and method 400 may be performed in parallel. For example, blocks 405 and 410 of method 400 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
creating, by a processor, a processor set in response to receiving an assignment of the processor set to an application;
in response to detecting an interrupt associated with the application, determining whether a processor core included in the processor set is unparked; and
in response to determining that the processor core is unparked, assigning, by the processor, the processor core to handle the interrupt.

2. The method of claim 1, wherein the processor set includes at least one processor core.

3. The method of claim 1, wherein the application is selected for optimization.

4. The method of claim 1, further comprising unparking the processor core in response to determining that the processor core is parked.

5. The method of claim 4, further comprising waiting a certain period after the unparking of the processor core.

6. The method of claim 1, further comprising if the processor core is parked, then masking out the processor core.

7. The method of claim 6, wherein prior to the masking out of the processor core, the method further comprises: determining whether the processor core is unmasked, and wherein the masking out of the processor core is performed if the processor core is unmasked.

8. The method of claim 1, wherein the processor core is an efficiency processor core.

9. An information handling system, comprising:
a memory to store an interrupt steering mode; and
a processor to communicate with the memory, the processor to:
create a processor set in response to receiving an assignment of the processor set to an application;
in response to detecting an interrupt associated with the application, measure a current load of a particular processor included in the processor set; and
if the current load of the processor is less than a target processor load, then assign the particular processor to handle the interrupt, wherein the assignment of the particular processor is further based on the interrupt steering mode.

10. The information handling system of claim 9, wherein if the current load of the particular processor is greater than the target processor load, then the processor to mask out the particular processor.

11. The information handling system of claim 10, wherein the masking out of the particular processor is performed if the particular processor is unmasked.

12. The information handling system of claim 9, wherein the target processor load is based on a processor power management policy.

13. The information handling system of claim 9, wherein the application is selected for optimization.

14. The information handling system of claim 9, wherein if the current load of the particular processor is equal to the target processor load, then the processor to assign the particular processor to handle the interrupt.

15. The information handling system of claim 9, wherein the processor further to determine a percentage of processor time attributed to running an interrupt service routine.

16. A non-transitory computer-readable medium to store instructions that are executable to perform operations comprising:
determining an application to be optimized for lower latency;
if a current setting of the application is optimized, retrieving an affinity mask associated with the application, wherein the affinity mask is further associated with a processor set to handle an interrupt that is associated with the application; and
assigning the interrupt to the processor set.

17. The non-transitory computer-readable medium of claim 16, wherein the operations further comprise assigning a thread associated with the application to the processor set.

18. The non-transitory computer-readable medium of claim 16, wherein the current setting of the application is optimized if quality of service requirements of the application are met.

19. The non-transitory computer-readable medium of claim 16, wherein the operations further comprise if the current setting of the application is not optimized, then opening a reference to a device driver that controls an interrupt controller associated with the interrupt.

20. The non-transitory computer-readable medium of claim 19, wherein the operations further comprise communicating with the device driver through input and output control calls.
